(19) United States
(12) Patent Application Publication
(10) Pub. No.: US 2025/0202212 A1
(43) Pub. Date: Jun. 19, 2025

(54) BUSBAR HOLDER

(71) Applicant: YAZAKI CORPORATION, Tokyo (JP)

(72) Inventors: Tomohiro Urashima, Nasukarasuyama-shi (JP); Genki Furuya, Nasukarasuyama-shi (JP); Kohki Nakamura, Nasukarasuyama-shi (JP); Hiroyasu Furuya, Nasukarasuyama-shi (JP)

(21) Appl. No.: 18/986,583

(22) Filed: Dec. 18, 2024

(30) Foreign Application Priority Data
Dec. 19, 2023 (JP) 2023-213601

(51) Int. Cl. H02G 5/04

(52) U.S. Cl. CPC H02G 5/04

(57) ABSTRACT

A busbar holder includes: a retainer that holds a straight portion of a first busbar covered with an insulation coating and a straight portion of a second busbar covered with an insulation coating in parallel alignment; a first cover coupled to the retainer via a first hinge part; a second cover coupled to the retainer via a second hinge part; a first retaining mechanism that holds the first cover on the retainer in a closed position; and a second retaining mechanism that holds the second cover on the retainer in a closed position. The retainer includes a first fitting housing chamber into which the straight portion of the first busbar inserted through a first insertion opening is fitted and housed and a second fitting housing chamber into which the straight portion of the second busbar inserted through a second insertion opening is fitted and housed.

### CROSS-REFERENCE TO RELATED APPLICATION(S)

The present application claims priority to and incorporates by reference the entire contents of Japanese Patent Application No. 2023-213601 filed in Japan on Dec. 19, 2023.

### BACKGROUND OF THE INVENTION

### 1. Field of the Invention

The present invention relates to a busbar holder.

### 2. Description of the Related Art

Conventionally, a busbar may be housed and held in a housing chamber of a busbar holder. For example, Japanese Patent Application Laid-open No. JP 2018-014297 A discloses a technology including a first housing chamber in which a plurality of busbars are housed and held, a second housing chamber in which a voltage detection wire is housed, a first cover that covers the first housing chamber, a second cover that covers the second housing chamber, a hinge that opens and closes the first cover, and a hinge that opens and closes the second cover. In addition, Japanese Patent Application Laid-open No. JP 2014-007105 A discloses a technology including a busbar holding part with busbar housing parts provided for respective two busbars, a busbar covering part that covers each busbar housing part, and a hinge part that allows the busbar covering part to be opened and closed.

However, in the technologies in the related art, all busbars can be removed when one cover is opened, and there is thus room for improvement from the viewpoint of preventing incorrect removal of a busbar to be removed.

### SUMMARY OF THE INVENTION

Thus, an object of the present invention is to provide a busbar holder capable of allowing a plurality of busbars to be individually removed.

In order to achieve the above mentioned object, a busbar holder according to one aspect of the present invention includes a retainer that holds a straight portion of a first busbar covered with an insulation coating and a straight portion of a second busbar covered with an insulation coating in parallel alignment; a first cover that is coupled to the retainer via a first hinge part; a second cover that is coupled to the retainer via a second hinge part; a first retaining mechanism that holds the first cover on the retainer in a closed position; and a second retaining mechanism that holds the second cover on the retainer in a closed position, wherein the retainer includes a first fitting housing chamber into which the straight portion of the first busbar inserted through a first insertion opening is fitted and housed, and a second fitting housing chamber into which the straight portion of the second busbar inserted through a second insertion opening is fitted and housed, the first cover is formed in a shape that covers the first insertion opening except for a part in the closed position, and the second cover is formed in a shape that covers the part of the first insertion opening and covers the second insertion opening in the closed position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective diagram illustrating a busbar holder of an embodiment, with a first cover and a second cover being in the open position;

FIG. 2 is a perspective diagram illustrating the busbar holder of the embodiment, with the first cover being in the closed position and the second cover being in the open position;

FIG. 3 is a perspective diagram illustrating the busbar holder of the embodiment, with the first cover and the second cover being in the closed position;

FIG. 4 is a perspective diagram illustrating the busbar holder of the embodiment, with the first cover and the second cover being in the open position and a first busbar and a second busbar being housed;

FIG. 5 is a perspective diagram illustrating the busbar holder of the embodiment, with the first cover and the second cover being in the closed position and the first busbar and the second busbar being housed;

FIG. 6 is a perspective diagram illustrating a busbar holder of a modification, with a first cover and a second cover being in the open position;

FIG. 7 is a perspective diagram illustrating the busbar holder of the modification, with the first cover being in the closed position and the second cover being in the open position;

FIG. 8 is a perspective diagram illustrating the busbar holder of the modification, with the first cover and the second cover being in the closed position;

FIG. 9 is a perspective diagram illustrating the busbar holder of the modification, with the first cover and the second cover being in the open position and a first busbar and a second busbar being housed; and

FIG. 10 is a perspective diagram illustrating the busbar holder of the modification, with the first cover and the second cover being in the closed position and the first busbar and the second busbar being housed.

### DETAILED DESCRIPTION OF THE PREFERRED EMBODIMENTS

Hereinbelow, an embodiment of a busbar holder according to the present invention will be described in detail with reference to the drawings. Note that this invention is not limited to this embodiment.

### EMBODIMENT

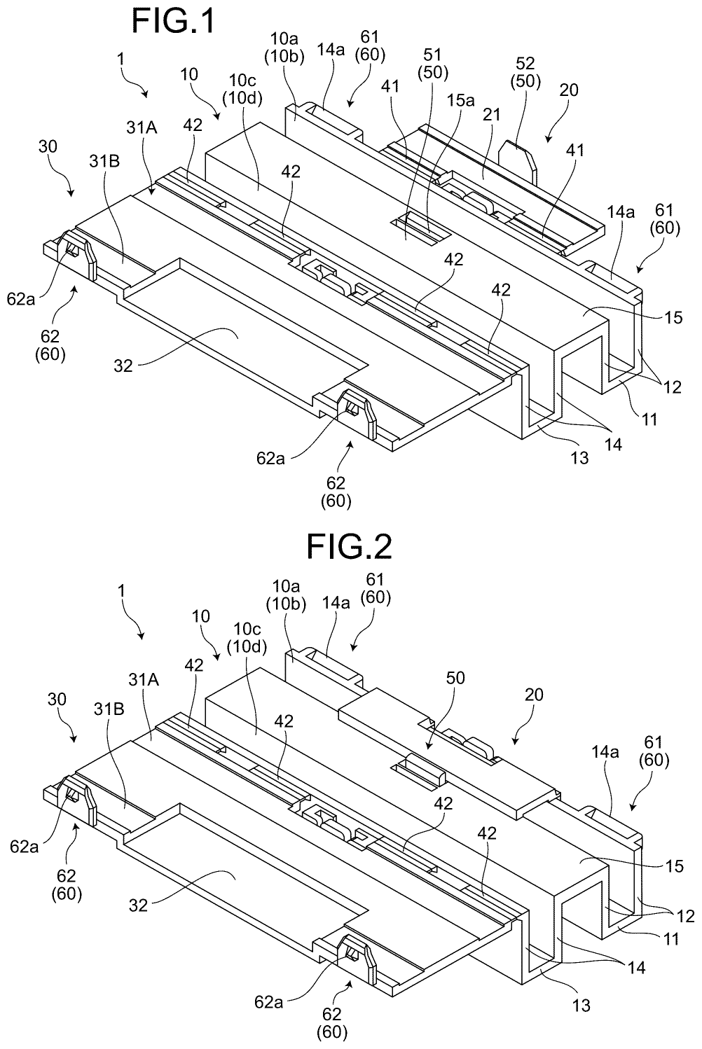

One embodiment of a busbar holder according to the present invention will be described with reference to FIGS. 1 to 5.

Reference numeral 1 in FIGS. 1 to 5 indicates a busbar holder of the present embodiment.

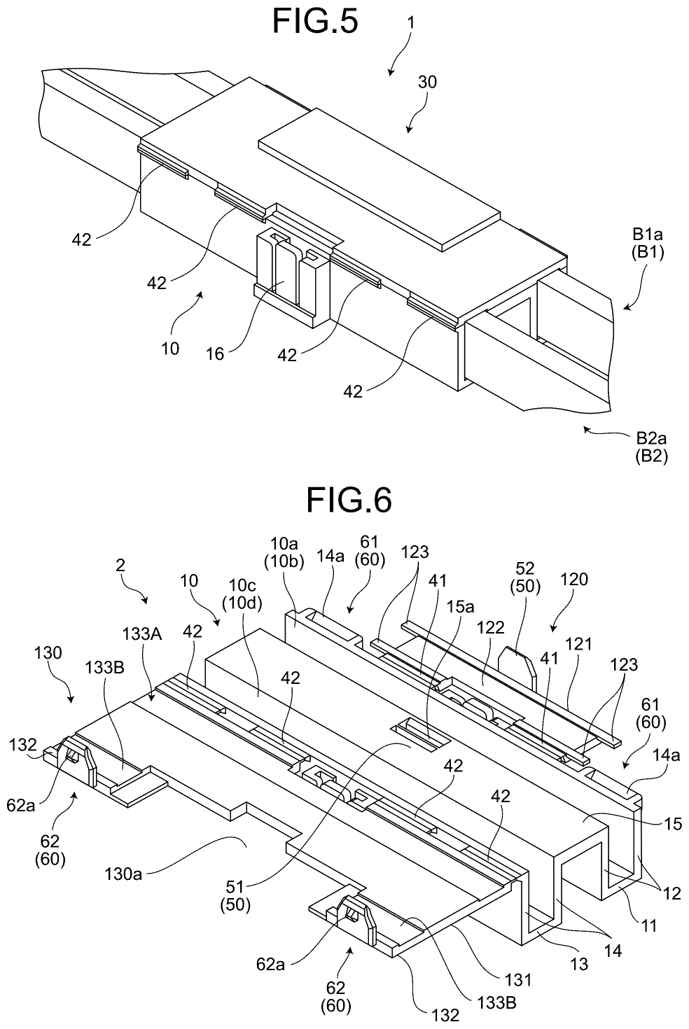

A busbar holder 1 is a member configured to house and hold a part of a first busbar B1 covered with an insulation coating and a part of a second busbar B2 covered with an insulation coating (FIGS. 4 and 5), and is attached to a vehicle body of a vehicle such as an automobile. This busbar holder 1 is molded from an insulating material such as a synthetic resin. Note that the first busbar B1 and the second busbar B2 are used, for example, to distribute power from a secondary battery of a vehicle, one of the first busbar B1 or the second busbar B2 is used as the positive side, and the other is used as the negative side.

The busbar holder 1 includes a retainer 10 that holds a straight portion B1a of the first busbar B1 and a straight portion B2a of the second busbar B2 in parallel alignment (FIGS. 1 to 5). This retainer 10 includes a first fitting housing chamber 10b into which the straight portion B1a of the first busbar B1 inserted through a first insertion opening 10a is fitted and housed, and a second fitting housing chamber 10d into which the straight portion B2a of the second busbar B2 inserted through a second insertion opening 10c is fitted and housed.

Specifically, the retainer 10 illustrated here includes a first bottom wall 11, a pair of first side walls 12 spaced apart from each other and standing vertically from the first bottom wall 11, a second bottom wall 13, and a pair of second side walls 14 spaced apart from each other and standing vertically from the second bottom wall 13 (FIGS. 1 to 3).

In this retainer 10, each of the first bottom wall 11, the pair of first side walls 12, the second bottom wall 13, and the pair of second side walls 14 is formed in a rectangular flat shape. Then, in this retainer 10, the first bottom wall 11 and the second bottom wall 13 are disposed to be spaced apart from each other on the same plane, and the pair of first side walls 12 and the pair of second side walls 14 are disposed opposite to and spaced apart from each other with the planes thereof facing each other. The pair of first side walls 12 stands vertically from two edges of the first bottom wall 11, respectively, with the two edge sides functioning fixed ends. In addition, the pair of second side walls 14 stands vertically from two edges of the second bottom wall 13, respectively, with the two edge sides functioning fixed ends. Therefore, the retainer 10 has a rectangular-parallelpiped space surrounded by the first bottom wall 11 and the pair of first side walls 12, the space being used as the first fitting housing chamber 10b. In this retainer 10, since the first fitting housing chamber 10b is formed with the first bottom wall 11 and the pair of first side walls 12, a rectangular opening on the free end side of the pair of first side walls 12 is used as a first insertion opening 10a. In addition, the retainer 10 has a rectangular-parallelpiped space surrounded by the second bottom wall 13 and the pair of second side walls 14, the space being used as the second fitting housing chamber 10d. In this retainer 10, since the second fitting housing chamber 10d is formed with the second bottom wall 13 and the pair of second side walls 14, a rectangular opening on the free end side of the pair of second side walls 14 is used as a second insertion opening 10c.

In the retainer 10 illustrated here, one first side wall 12 and one second side wall 14 are disposed on the outer wall side, and a free end of the other first side wall 12 and a free end of the other second side wall 14 on the inner wall side are coupled by a rectangular flat connecting wall 15 (FIGS. 1 to 3).

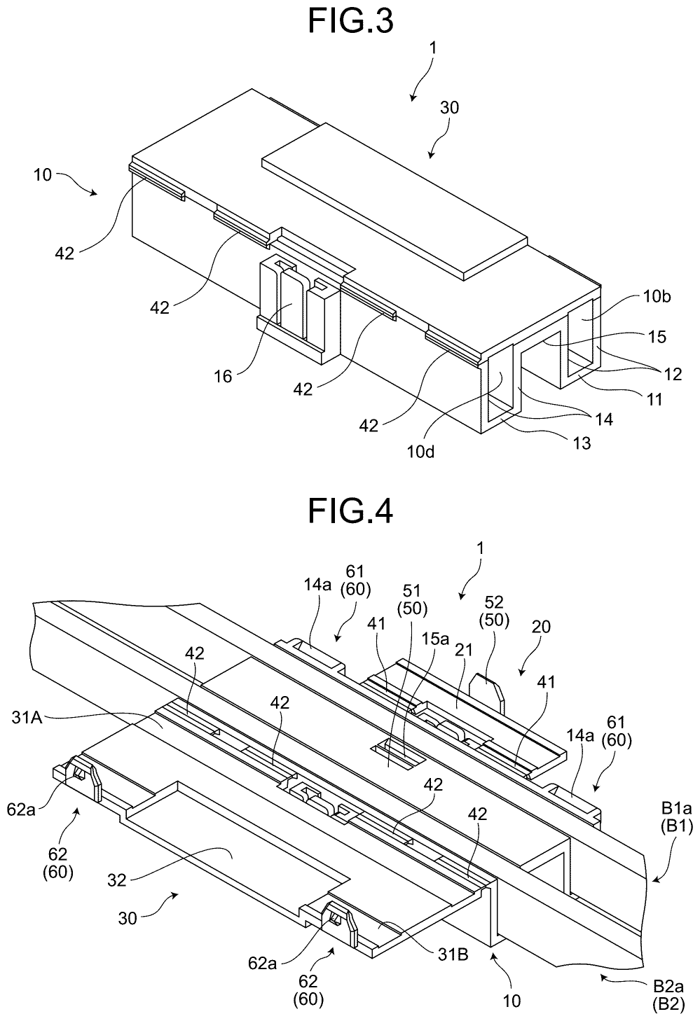

This retainer 10 includes a securing part 16 that secures the retainer 10 itself to a vehicle body (FIGS. 3 and 5). This securing part 16 is provided on an outer wall surface of at least one of the one first side wall 12 or the one second side wall 14. For example, the securing part 16 may have any form, such as a form to be inserted into and fitted with a piece part provided on the vehicle body side, or to be screw-fixed to the vehicle body side.

Furthermore, the busbar holder 1 includes a first cover 20 and a second cover 30 (FIGS. 1 to 5).

The first cover 20 is formed in a shape that covers the first insertion opening 10a except for parts thereof in the closed position (FIG. 2). In addition, the second cover 30 is formed in a shape that covers the parts of the first insertion opening 10a and covers the second insertion opening 10c in the closed position (FIG. 3). The first cover 20 illustrated here covers a portion of the rectangular first insertion opening 10a except for both ends in the longitudinal direction in the closed position. Then, the second cover 30 illustrated here covers both the ends of the rectangular first insertion opening 10a in the longitudinal direction and the entire second insertion opening 10c in the closed position.

The first cover 20 is formed with a fitting groove 21 that is fitted with an end portion of the straight portion B1a of the first busbar B1 housed in the first fitting housing chamber 10b in the closed position (FIGS. 1 and 4). In addition, the second cover 30 is formed with a fitting groove 31A that is fitted with an end portion of the straight portion B2a of the second busbar B2 housed in the second fitting housing chamber 10d in the closed position, and fitting grooves 31B that are fitted with the end portion of the straight portion B1a of the first busbar B1 housed in the first fitting housing chamber 10b in the closed position (FIGS. 1, 2, and 4).

The first cover 20 illustrated here is formed in a rectangular flat shape (FIGS. 1, 2, and 4). In addition, the second cover 30 illustrated here is formed in a rectangular flat shape, which can cover the entire first insertion opening 10a and the entire second insertion opening 10c in the closed position, and covers the first cover 20 in the closed position when the second cover is in the closed position (FIGS. 1 to 5). Therefore, this second cover 30 is formed with a recessed portion 32 that is fitted with the first cover 20 in the closed position when the second cover 30 is in the closed position (FIGS. 1, 2, and 4). This recessed portion 32 is formed in a rectangular shape to be matched with the shape of the first cover 20 and covers the first cover 20 from the outside to be fitted with the first cover 20 in the closed position when the second cover 30 is in the closed position.

The first cover 20 is coupled to the retainer 10 via first hinge parts 41 (FIGS. 1 and 4). These first hinge parts 41 couple a fixed end of the first cover 20 to the one first side wall 12 and hold the first cover 20 in a cantilevered state to allow the first cover 20 to be opened and closed between the open position and the closed position. The first hinge parts 41 illustrated here are formed as what is called living hinges. Here, the first hinge parts 41 are respectively provided at end portions of the first cover 20 in the longitudinal direction.

The second cover 30 is coupled to the retainer 10 via second hinge parts 42 (FIGS. 1 to 5). These second hinge parts 42 couple a fixed end of the second cover 30 to the one second side wall 14 and hold the second cover 30 in a cantilevered state to allow the second cover 30 to be opened and closed between the open position and the closed position. The second hinge parts 42 illustrated here are formed as what is called living hinges. Here, the second hinge parts 42 are respectively provided at both end portions of the second cover 30 in the longitudinal direction, and two second hinge parts 42 are further provided between the second hinge parts 42 at both ends.

Furthermore, the busbar holder 1 has a first retaining mechanism 50 that holds the first cover 20 on the retainer 10 in the closed position and second retaining mechanisms 60 that hold the second cover 30 on the retainer 10 in the closed position (FIGS. 1, 2, and 4).

The first retaining mechanism 50 is provided with a first cover engaging part 51 provided on the retainer 10 and a first cover engaged part 52 provided on a free end of the first cover 20 (FIGS. 1, 2, and 4). This first retaining mechanism 50 engages the first cover engaging part 51 with the first cover engaged part 52 in the closed position to hold the first cover 20 on the retainer 10 in the closed position. In the first retaining mechanism 50 illustrated here, the peripheral portion of a through-hole 15a provided in the connecting wall 15 is used as the first cover engaging part 51, and a claw portion, for example, of the first cover engaged part 52, which is inserted into the through-hole 15a in the closed position, is hooked onto the first cover engaging part 51 to hold the first cover 20 on the retainer 10 in the closed position.

Each of the second retaining mechanisms 60 is provided with a second cover engaging part 61 provided on the retainer 10 and a second cover engaged part 62 provided on a free end of the second cover 30 (FIGS. 1, 2, and 4). This second retaining mechanism 60 engages the second cover engaging part 61 with the second cover engaged part 62 in the closed position to hold the second cover 30 on the retainer 10 in the closed position. In each of the second retaining mechanisms 60 illustrated here, an annular end face of a tubular portion 14a that protrudes from the outer wall surface of the other second side wall 14 is used as the second cover engaging part 61, and a claw portion 62a of the second cover engaged part 62, which is inserted into the tubular portion 14a, is hooked onto the second cover engaging part 61 to hold the second cover 30 on the retainer 10 in the closed position. These second retaining mechanisms 60 are respectively provided at end portions of the second cover 30 in the longitudinal direction.

In the busbar holder 1 described above, the straight portion B1a of the first busbar B1 is housed in the first fitting housing chamber 10b when the first cover 20 and the second cover 30 are in the open position (FIGS. 1 and 4). Then, in this busbar holder 1, the first cover 20 is rotationally moved into the closed position, and this first cover 20 is held by the first retaining mechanism 50 in the closed position (FIG. 2). Note that, in FIG. 2, the first busbar B1 is omitted for convenience of illustration. In addition, in FIG. 4, the straight portion B2a of the second busbar B2 is also housed in the second fitting housing chamber 10d for convenience of illustration.

Next, in this busbar holder 1, the straight portion B2a of the second busbar B2 is housed in the second fitting housing chamber 10d while the second cover 30 is in the open position (FIG. 4). Then, in this busbar holder 1, the second cover 30 is rotationally moved into the closed position, and this second cover 30 is held by the second retaining mechanisms 60 in the closed position (FIG. 5).

In this busbar holder 1, in a case of removing the second busbar B2 when the first cover 20 and the second cover 30 are in the closed position, it is sufficient to open the second cover 30 to the open position. Then, in this busbar holder 1, in a case of removing the first busbar B1 when the first cover 20 and the second cover 30 are in the closed position, it is necessary to open both the first cover 20 and the second cover 30 to the open position.

Thus, the busbar holder 1 of the present embodiment enables the removal of a busbar to be removed among a plurality of busbars (first busbar B1 and second busbar B2) individually. Therefore, this busbar holder 1 is useful in preventing the incorrect removal of the busbar to be removed. Since this busbar holder 1 can also be used to remove the busbars (first busbar B1 and second busbar B2) one by one, it is possible to control electrical conduction caused by contact between the bus bars.

Furthermore, in this busbar holder 1, since the first cover 20 in the closed position is covered by the second cover 30 in the closed position, the first cover 20 cannot be opened without opening the second cover 30. Therefore, in this busbar holder 1, in the case of removing the first busbar B1 when the first cover 20 and the second cover 30 are in the closed position, it is necessary to open the second cover 30 to the open position, and then to open the first cover 20 to the open position. Therefore, the busbar holder 1 of the present embodiment can prevent the incorrect removal of the busbar to be removed in a more suitable condition, and can also control electrical conduction caused by contact between the busbars in a more suitable condition.

In addition, the busbar holder 1 of the present embodiment adopts the form in which the straight portions B1a and B2a of the first busbar B1 and second busbar B2 are individually assembled. Thus, this busbar holder 1 enables the minimization of the body size. Then, this busbar holder 1 can be freely set with assembly positions within the range of the respective straight portions B1a and B2a of the first busbar B1 and second busbar B2. Therefore, the busbar holder 1 of the present embodiment can easily follow busbar routing paths in various vehicles, and can be made versatile.

In addition, since the busbar holder 1 of the present embodiment adopts the form in which the straight portions B1a and B2a of the first busbar B1 and second busbar B2 are individually assembled, it is possible to reduce the number of first retaining mechanisms 50 and second retaining mechanisms 60 and to improve the workability of assembly with respect to the first busbar B1 and the second busbar B2, as compared to a busbar holder housing all the first busbar B1 and the second busbar B2.

In addition, since the busbar holder 1 of the present embodiment adopts an integral structure in which the first cover 20 and the second cover 30 are coupled to the retainer 10 via the first hinge parts 41 and the second hinge parts 42, respectively, it is possible to reduce the number of parts and to improve the workability of assembly with respect to the first busbar B1 and the second busbar B2.

### Modification

Reference numeral 2 in FIGS. 6 to 10 indicates a busbar holder of the present modification. A busbar holder 2 of the present modification corresponds to the busbar holder 1 of the aforementioned embodiment, in which the first cover 20 and the second cover 30 are replaced by a first cover 120 and a second cover 130 (FIGS. 6 to 10). Therefore, in the busbar holder 2 of the present modification, the same parts as those in the busbar holder 1 of the embodiment are denoted by the same reference numerals as those in the embodiment, and the descriptions thereof will not be repeated.

The first cover 120 of the present modification includes a cover main body 121 formed in the same shape as the first cover 20 of the aforementioned embodiment, and covers a first insertion opening 10a of a retainer 10 with the cover main body 121 in the closed position, except for parts thereof (both ends of the first insertion opening 10a in the longitudinal direction) (FIGS. 6 to 10).

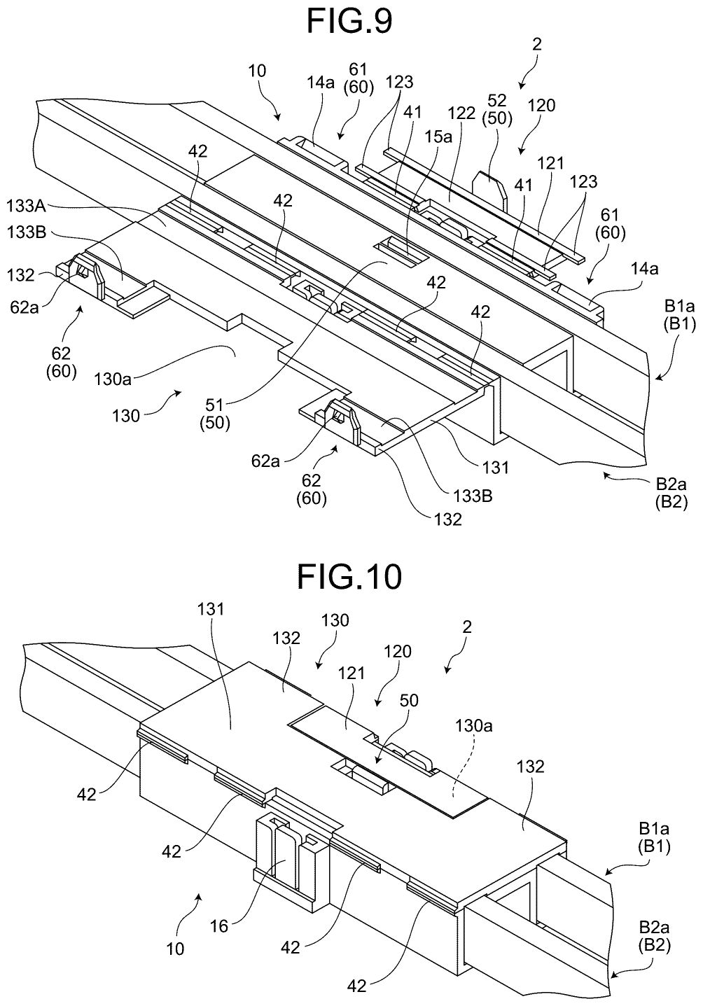

Similar to the first cover 20 of the embodiment, a fixed end of the cover main body 121 is coupled to one first side wall 12 of the retainer 10 via first hinge parts 41 (FIGS. 6 and 9). In addition, similar to the first cover 20 of the embodiment, this cover main body 121 includes a first cover engaged part 52 at a free end thereof, and is held on the retainer 10 by the engagement of this first cover engaged part 52 with a first cover engaging part 51 of the retainer 10 in the closed position (FIGS. 6 to 10). In addition, similar to the first cover 20 of the embodiment, this cover main body 121 is formed with a fitting groove 122 that is fitted with an end portion of a straight portion B1a of a first busbar B1 housed in a first fitting housing chamber 10b in the closed position (FIGS. 6 and 9).

Similar to the second cover 30 of the aforementioned embodiment, the second cover 130 of the present modification is formed in a shape that covers the end parts of the first insertion opening 10a (both ends of the first insertion opening 10a in the longitudinal direction) of the retainer 10 and covers a second insertion opening 10c of the retainer 10 in the closed position (FIGS. 6 to 10).

However, unlike the second cover 30 of the embodiment, the second cover 130 of the present modification has a cutout portion 130a that is fitted with the first cover 120 in the closed position when the second cover 130 is in the closed position (FIGS. 6 to 10). This second cover 130 is formed in a shape including a main body part 131 that covers the second insertion opening 10c and piece parts 132 that protrude from this main body part 131 and cover the end parts of the first insertion opening 10a (both ends of the first insertion opening 10a in the longitudinal direction) (FIGS. 6 to 10). In this second cover 130, the cutout portion 130a is provided adjacent to the main body part 131 and the piece parts 132. The main body part 131 illustrated here is formed in a rectangular flat shape. In addition, the piece parts 132 illustrated here are formed in a rectangular flat shape, and respectively protrude from two ends of the main body part 131 in the longitudinal direction. The cutout portion 130a is disposed between the pair of piece parts 132.

Similar to the second cover 30 of the embodiment, a fixed end of the second cover 130 (fixed end of the main body part 131) of the present modification is coupled to one second side wall 14 of the retainer 10 via second hinge parts 42 (FIGS. 6 to 10). In addition, similar to the second cover 30 of the embodiment, this second cover 130 includes second cover engaged parts 62 at free ends thereof (respective free ends of the pair of piece parts 132), and are held on the retainer 10 by the engagement of these second cover engaged parts 62 with second cover engaging parts 61 of the retainer 10 in the closed position (FIGS. 6 to 10). In addition, similar to the second cover 30 of the embodiment, this second cover 130 is formed with a fitting groove 133A that is fitted with an end portion of a straight portion B2a of a second busbar B2 housed in a second fitting housing chamber 10d in the closed position, and fitting grooves 133B that are fitted with the end portion of the straight portion B1a of the first busbar B1 housed in the first fitting housing chamber 10b in the closed position (FIGS. 6, 7, and 9). The fitting groove 133A is formed on the main body part 131. Then, the fitting grooves 133B are respectively formed on the piece parts 132.

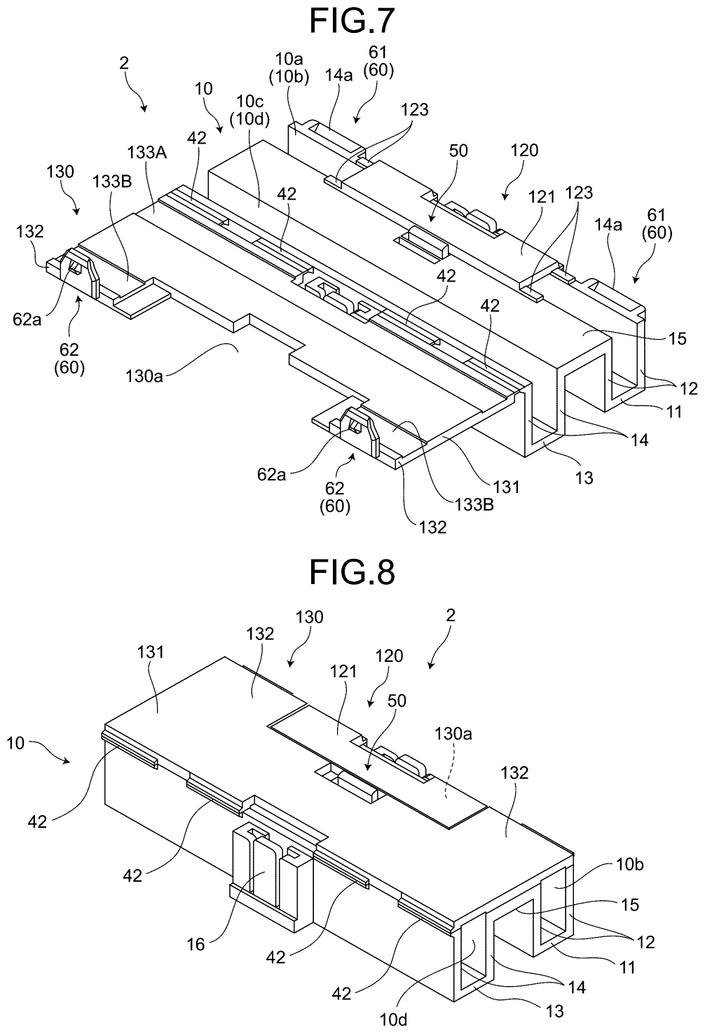

Similar to the busbar holder 1 of the embodiment, in the busbar holder 2 of the present modification, the straight portion B1a of the first busbar B1 is housed in the first fitting housing chamber 10b when the first cover 120 and the second cover 130 are in the open position (FIGS. 6 and 9). Then, similar to the busbar holder 1 of the embodiment, in this busbar holder 2, the first cover 120 is rotationally moved into the closed position, and this first cover 120 is held by the first retaining mechanism 50 in the closed position (FIG. 7). Note that, in FIG. 7, the first busbar B1 is omitted for convenience of illustration. In addition, in FIG. 9, the straight portion B2a of the second busbar B2 is also housed in the second fitting housing chamber 10d for convenience of illustration.

Next, similar to the busbar holder 1 of the embodiment, in this busbar holder 2, the straight portion B2a of the second busbar B2 is housed in the second fitting housing chamber 10d while the second cover 130 is in the open position (FIG. 9). Then, similar to the busbar holder 1 of the embodiment, in this busbar holder 2, the second cover 130 is rotationally moved into the closed position, and this second cover 130 is held by the second retaining mechanisms 60 in the closed position (FIG. 10).

Similar to the busbar holder 1 of the embodiment, in this busbar holder 2, in a case of removing the second busbar B2 when the first cover 120 and the second cover 130 are in the closed position, it is sufficient to open the second cover 130 to the open position. Then, similar to the busbar holder 1 of the embodiment, in this busbar holder 2, in a case of removing the first busbar B1 when the first cover 120 and the second cover 130 are in the closed position, it is necessary to open both the first cover 120 and the second cover 130 to the open position.

Thus, similar to the busbar holder 1 of the embodiment, the busbar holder 2 of the present modification enables the removal of a busbar to be removed among a plurality of busbars (first busbar B1 and second busbar B2) individually. Therefore, this busbar holder 2 is useful in preventing the incorrect removal of the busbar to be removed. In addition, similar to the busbar holder 1 of the embodiment, since this busbar holder 2 can also be used to remove the busbars (first busbar B1 and second busbar B2) one by one, it is possible to control electrical conduction caused by contact between the bus bars.

Here, similar to the busbar holder 1 of the embodiment, this busbar holder 2 may have a configuration in which the first cover 120 cannot be opened without opening the second cover 130. For example, in this busbar holder 2, locking parts 123 protrude from the cover main body 121 of the first cover 120 in the closed position toward the end parts of the first insertion opening 10a (both ends of the first insertion opening 10a in the longitudinal direction) (FIGS. 6, 7, and 9), and these locking parts 123 in the closed position are covered by the piece parts 132 of the second cover 130 in the closed position. Accordingly, in this busbar holder 2, since these locking parts 123 are covered by the piece parts 132 of the second cover 130 in a case where an attempt is made to open the first cover 120 in the closed position, the first cover 120 in the closed position cannot be opened without opening the second cover 130 in the closed position. Therefore, similar to the busbar holder 1 of the embodiment, in this busbar holder 2, in the case of removing the first busbar B1 when the first cover 120 and the second cover 130 are in the closed position, it is necessary to open the second cover 130 to the open position, and then to open the first cover 120 to the open position. Therefore, similar to the busbar holder 1 of the embodiment, the busbar holder 2 of the present modification can prevent the incorrect removal of the busbar to be removed in a more suitable condition, and can also control electrical conduction caused by contact between the busbars in a more suitable condition. Here, two of the locking parts 123 protrude from one end of the cover main body 121 in the longitudinal direction in the closed position toward one end portion of the first insertion opening 10a in the longitudinal direction, and two of the locking parts 123 protrude from the other end portion of the cover main body 121 in the longitudinal direction in the closed position toward the other end of the first insertion opening 10a in the longitudinal direction.

In addition, similar to the busbar holder 1 of the embodiment, the busbar holder 2 of the present modification adopts the form in which the straight portions B1a and B2a of the first busbar B1 and second busbar B2 are individually assembled. Thus, similar to the busbar holder 1 of the embodiment, this busbar holder 2 enables the minimization of the body size, and can also be freely set with assembly positions within the range of the respective straight portions B1a and B2a of the first busbar B1 and second busbar B2. Therefore, similar to the busbar holder 1 of the embodiment, the busbar holder 2 of the present modification can easily follow busbar routing paths in various vehicles, and can be made versatile.

In addition, similar to the busbar holder 1 of the embodiment, since the busbar holder 2 of the present modification adopts the form in which the straight portions B1a and B2a of the first busbar B1 and second busbar B2 are individually assembled, it is possible to reduce the number of first retaining mechanisms 50 and second retaining mechanisms 60 and to improve the workability of assembly with respect to the first busbar B1 and the second busbar B2, as compared to a busbar holder housing all the first busbar B1 and the second busbar B2.

In addition, similar to the busbar holder 1 of the embodiment, since the busbar holder 2 of the present modification adopts an integral structure in which the first cover 120 and the second cover 130 are coupled to the retainer 10 via the first hinge parts 41 and the second hinge parts 42, respectively, it is possible to reduce the number of parts and to improve the workability of assembly with respect to the first busbar B1 and the second busbar B2.

In the busbar holder according to the present embodiment, in a case of removing the second busbar when the first cover and the second cover are in the closed position, it is sufficient to open the second cover to the open position. Then, in this busbar holder, in a case of removing the first busbar when the first cover and the second cover are in the closed position, it is necessary to open both the first cover and the second cover to the open position. As described above, the busbar holder according to the present embodiment enables the removal of a busbar to be removed among the first busbar and the second busbar individually. Therefore, this busbar holder is useful in preventing the incorrect removal of the busbar to be removed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A busbar holder comprising:
a retainer that holds a straight portion of a first busbar covered with an insulation coating and a straight portion of a second busbar covered with an insulation coating in parallel alignment;
a first cover that is coupled to the retainer via a first hinge part;
a second cover that is coupled to the retainer via a second hinge part;
a first retaining mechanism that holds the first cover on the retainer in a closed position; and
a second retaining mechanism that holds the second cover on the retainer in a closed position, wherein
the retainer includes a first fitting housing chamber into which the straight portion of the first busbar inserted through a first insertion opening is fitted and housed, and a second fitting housing chamber into which the straight portion of the second busbar inserted through a second insertion opening is fitted and housed,
the first cover is formed in a shape that covers the first insertion opening except for a part in the closed position, and
the second cover is formed in a shape that covers the part of the first insertion opening and covers the second insertion opening in the closed position.

2. The busbar holder according to claim 1, wherein
in the retainer, the first fitting housing chamber is formed with a first bottom wall and a pair of first side walls spaced apart from each other and standing vertically from the first bottom wall, and the second fitting housing chamber is formed with a second bottom wall and a pair of second side walls spaced apart from each other and standing vertically from the second bottom wall,
the first hinge part couples a fixed end of the first cover to one of the first side walls and holds the first cover in a cantilevered state to allow the first cover to be opened and closed between an open position and the closed position,
the second hinge part couples a fixed end of the second cover to one of the second side walls and holds the second cover in a cantilevered state to allow the second cover to be opened and closed between an open position and the closed position,
the first retaining mechanism engages a first cover engaging part provided on the retainer with a first cover engaged part provided on a free end of the first cover in the closed position, and
the second retaining mechanism engages a second cover engaging part provided on the retainer with a second cover engaged part provided on a free end of the second cover in the closed position.

3. The busbar holder according to claim 1, wherein
the second cover covers the first cover in the closed position when the second cover is in the closed position.

4. The busbar holder according to claim 2, wherein
the second cover covers the first cover in the closed position when the second cover is in the closed position.

5. The busbar holder according to claim 1, wherein
the second cover has a cutout portion that is fitted with the first cover in the closed position when the second cover is in the closed position.

6. The busbar holder according to claim 2, wherein
the second cover has a cutout portion that is fitted with the first cover in the closed position when the second cover is in the closed position.

7. The busbar holder according to claim 1, wherein
the retainer includes a securing part that secures the retainer itself to a vehicle body.

8. The busbar holder according to claim 2, wherein
the retainer includes a securing part that secures the retainer itself to a vehicle body.
